(19) United States
(12) Patent Application Publication
(10) Pub. No.: US 2010/0097735 A1
(43) Pub. Date: Apr. 22, 2010

(54) METHOD OF PROTECTING AND DISSIPATING ELECTROSTATIC DISCHARGES IN AN INTEGRATED CIRCUIT

(75) Inventor: Jean-François NODIN, Saint-Egreve (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: COMMISSARIAT A L' ENERGIE ATOMIQUE, Paris (FR)

(21) Appl. No.: 12/551,853

(22) Filed: Sep. 1, 2009

(30) Foreign Application Priority Data
Oct. 16, 2008 (FR) 08 57033

(51) Int. Cl. H02H 9/00

(52) U.S. Cl. 361/56

(57) ABSTRACT

A device for protecting at least one integrated circuit against an electrostatic discharge, comprising at least:
a portion of ionisable metal,
a solid electrolyte arranged against the portion of ionisable metal and comprising metal ions of nature similar to the metal of said portion of ionisable metal,
an electrode electrically connected to the solid electrolyte,
and in which the concentration of metal ions in the solid electrolyte is less than the saturation concentration of metal ions in the solid electrolyte.

### TECHNICAL FIELD

The invention relates to the field of integrated circuits and, more specifically, that of protecting integrated circuits against ESD (ElectroStatic Discharges) that can appear on the connection lines of said integrated circuits.

### STATE OF THE PRIOR ART

The majority of current electronic components implanted in integrated circuits are based on MOS (Metal-Oxide-Semiconductor) transistors. In these transistors, voltages of several volts greater than their supply voltage, which are typically between around 3.3 V and 5 V, can damage the gate oxide of these transistors. Thus, the lower the supply voltage of these components, the greater the sensitivity of these components to overvoltages.

The values of the voltages of electrostatic discharges (ESD) in a normal environment of an integrated circuit can generally attain several tens of volts, or even several hundreds of volts. These voltages may be destructive, even in the presence of low charges in the integrated circuit and thus low currents flowing through the integrated circuit during these discharges.

FIG. 1 represents an example of configuration in which an ESD protective device 10 is arranged between the inputs/outputs of an integrated circuit 16 comprising for example CMOS components, these inputs/outputs being represented by an electrical input/output line 12 and an earth 14. The ESD protective device 10 makes it possible to evacuate the electrostatic discharges or overvoltages appearing on the electrical input/output line 12 directly towards the earth 14 without these discharges passing through the integrated circuit 16, thereby protecting it from these overvoltages.

Such integrated ESD protective devices generally comprise an assembly of numerous components (diodes, MOS & bipolar transistors, resistors, etc.). Document U.S. Pat. No. 7,242,558 B2 discloses for example such an ESD protective device. Given the high number of components necessary for its formation, this protective device is bulky, which is a major drawback when it has to be integrated in the circuit that it is wished to protect. In addition, such an ESD protective device comprising a high number of components has the drawback of having a high parasitic capacitance limiting the pass band of the integrated circuit to be protected. Finally, this protective device only operates if the integrated circuit to be protected is on, given the necessity of supplying at least the transistors of this device.

Document U.S. Pat. No. 7,164,566 B2 discloses another type of ESD protective device. The device disclosed in this document comprises a complex architecture requiring numerous technological steps for its formation.

### DESCRIPTION OF THE INVENTION

Thus there is a need to propose a protective device that is not bulky, requiring few components and/or comprising a less complex architecture than that of devices of the prior art, making it possible to protect an integrated circuit when it is either on or off, and having a very low parasitic capacitance vis-à-vis the integrated circuit to be protected.

For this purpose, one embodiment of the present invention proposes a device for protecting at least one integrated circuit against an electrostatic discharge, comprising at least:

a portion of ionisable metal,

a solid electrolyte arranged against the portion of ionisable metal and comprising metal ions of similar nature to the metal of said portion of ionisable metal,

an electrode electrically connected, or coupled, to the solid electrolyte,

and in which the concentration of metal ions in the solid electrolyte is less than the saturation concentration of the metal ions in the solid electrolyte.

Such a protective device makes it possible to protect efficiently an integrated circuit against electrostatic discharges and does not require peripheral polarisation components. Said protective device is also not very bulky: typically, the diameter of the protective device may be equal to around 300 nm, and of thickness less than around 100 nm as regards the portion of ionisable metal and the solid electrolyte. Such a device makes it possible for example to dissipate a current equal to around 10 mA for a duration equal to around 1 second.

This protective device also has a very low parasitic capacitance to the protected integrated circuit (for example less than around 100 fF), and thus has a low impact on the operating pass band of the protected integrated circuit.

Finally, when the protective device is not subjected to an electrostatic discharge, it has a very high impedance (R>10⁹ ohms), thus entailing no leakage currents or very low leakage currents.

Advantageously, the protective device may further comprise a second electrode electrically connected, or coupled, to the portion of ionisable metal.

Advantageously, the portion of ionisable metal may be based on copper and/or silver, and/or the solid electrolyte may be based on a chalcogenide, and/or the electrode(s) may be based on nickel and/or tungsten.

The thickness of the electrode(s) may be between around 100 nm and 300 nm, and/or the thickness of the solid electrolyte may be between around 10 nm and 100 nm, and/or the thickness of the portion of ionisable metal may be between around 5 nm and 100 nm. When the layer of ionisable metal also assures the role of the electrode (the second electrode is in this case formed by the portion of ionisable metal itself), this may have a thickness less than around 500 nm, and for example equal to around 300 nm, or instead between around 300 nm and 500 nm.

The protective device may further comprise, when the material of the electrode(s) is suited to diffusing ions into the solid electrolyte, a portion of material preventing ion diffusion, forming an ion diffusion barrier, arranged between the electrode(s) and the solid electrolyte.

The protective device may further comprise a portion of resistive material of conductivity less than that of the material of the electrode(s), arranged between the electrode and the portion of ionisable metal, or between the electrodes. Such a portion of material makes it possible to limit the maximum current that can flow through the protective device.

The protective device may further comprise, when the material of said portion of resistive material is suited to diffusing ions into the solid electrolyte, an ion diffusion barrier arranged between said portion of material and the solid electrolyte.

The parts of the protective device may be surrounded by portions of electrically insulating material.

Another embodiment of the invention relates to a method of protecting at least one integrated circuit against an electrostatic discharge, comprising at least the electrical connection, or coupling, of at least one protective device as described above, to an electrical input and/or output line of the integrated circuit, one of the electrode or the portion of ionisable metal of the protective device being electrically connected, or coupled, to the electrical input and/or output line of the integrated circuit, the other being electrically connected, or coupled, to an earth.

The electrode or the portion of ionisable metal electrically connected, or coupled, to earth may be connected, or coupled, directly to earth, or be connected, or coupled, to earth by means of at least one electronic device such as a filter, a supply, a transformer or even a coupler.

When the protective device comprises a second electrode electrically connected, or coupled, to the portion of ionisable metal, the portion of ionisable metal may be electrically connected, or coupled, to the electrical input and/or output line of the integrated circuit or to earth by means of the second electrode.

The method may further comprise the electrical connection and/or the coupling of at least one second protective device as described above to the electrical input and/or output line of the integrated circuit, and in which, when the portion of ionisable metal of the first protective device is electrically connected, or coupled, to the electrical input and/or output line of the integrated circuit, the electrode of the second protective device may be electrically connected, or coupled, to the electrical input and/or output line of the integrated circuit and the portion of ionisable metal of the second protective device may be electrically connected, or coupled, to earth, and when the portion of ionisable metal of the first protective device is electrically connected, or coupled, to earth, the portion of ionisable metal of the second protective device may be electrically connected, or coupled, to the electrical input and/or output line of the integrated circuit and the electrode of the second protective device may be electrically connected, or coupled, to earth.

Preferably, when the second protective device comprises a second electrode electrically connected, or coupled, to the portion of ionisable metal of the second protective device, the portion of ionisable metal of the second protective device may be electrically connected, or coupled, to the electrical input and/or output line of the integrated circuit or to earth by means of the second electrode.

Another embodiment of the invention also relates to a method of dissipating an electrostatic discharge appearing on at least one electrical input and/or output line of at least one integrated circuit, comprising at least the steps of:

transfer of a current stemming from the electrostatic discharge into a protective device as described previously by means of an electrode or a portion of ionisable metal of the protective device electrically connected, or coupled, to the electrical input and/or output line of the integrated circuit or to an earth,

migration of metal ions, stemming from the portion of ionisable metal and diffused into a solid electrolyte of the protective device arranged against the portion of ionisable metal, into the solid electrolyte, lowering the resistivity of the assembly formed by at least the portion of ionisable metal and the solid electrolyte, and forming a conductive path between the electrode and the portion of ionisable metal,

evacuation of the current stemming from the electrostatic discharge through the protective device, by means of the electrode or the portion of ionisable metal electrically connected, or coupled, to earth.

During the migration of the metal ions, the resistivity of the assembly formed by the portion of ionisable metal and the solid electrolyte may be lowered from a R_{HI} value greater than around 10⁹ ohms to a R_{BI} value less than around 10³ ohms.

The dissipation method may further comprise, after the step of evacuation of the current stemming from the electrostatic discharge, a step of dispersing the metal ions having previously migrated into the solid electrolyte, which can increase the resistivity of the assembly formed by the portion of ionisable metal and the solid electrolyte.

In this case, during the dispersion of the metal ions, the resistivity of the assembly formed by the portion of ionisable metal and the solid electrolyte is increased from a R_{BI} value less than around 10³ ohms to a R_{HI} value greater than around 10⁹ ohms.

Another embodiment of the invention may also relate to the use of a semi-conductor device for protecting at least one integrated circuit against an electrostatic discharge appearing on at least one electrical input and/or output line of the integrated circuit, the semi-conductor device comprising at least:

a portion of ionisable metal,

a solid electrolyte arranged against the portion of ionisable metal and comprising metal ions stemming from said portion of ionisable metal,

an electrode electrically connected, or coupled, to the solid electrolyte,

the concentration of metal ions in the solid electrolyte being less than the saturation concentration of the metal ions in the solid electrolyte,

one of the electrodes or the portion of ionisable metal being electrically connected, or coupled, to the electrical input and/or output line of the integrated circuit, the other being electrically connected, or coupled, to an earth.

### BRIEF DESCRIPTION OF DRAWINGS

The present invention will be better understood on reading the description of embodiments, given purely by way of indication and in no way limiting, and by referring to the appended figures in which:

FIG. 1 represents a configuration for protecting an integrated circuit by an ESD protective device according to the prior art,

FIG. 2 represents a protective device according to a first embodiment used for protecting an integrated circuit against electrostatic discharges,

FIG. 3 represents a protective device according to a second embodiment used for protecting an integrated circuit against electrostatic discharges,

FIG. 4 graphically represents the variation in the conductivity of the protective device according to the first or the second embodiment as a function of the value of the voltage applied between the electrodes of said protective device,

FIG. 5 represents a configuration in which an integrated circuit is protected by two protective devices,

FIG. 6 represents a configuration in which an integrated circuit is protected by six protective devices.

Identical, similar or equivalent parts of the different figures described hereafter bear the same number references so as to make it easier to go from one figure to the next.

In order to make the figures easier to read, the different parts represented in the figures are not necessarily to the same scale.

The different possibilities (alternatives and embodiments) should be understood as not been mutually exclusive and may be combined together.

### DETAILED DESCRIPTION OF SPECIFIC EMBODIMENTS

Reference will firstly be made to FIG. 2, which represents a protective device 100 according to a first embodiment used for protecting an integrated circuit against electrostatic discharges.

This device 100 comprises a lower electrode 102 based on a conductor material, for example based on an inert metal such as tungsten and/or nickel, on which is arranged a solid electrolyte 104, for example based on chalcogenide, doped or not, such as GeSe, and/or GeS and/or WOₓ and/or based on tellurium. The lower electrode 102 has for example a thickness between around 100 nm and 300 nm. The solid electrolyte 104 has for example a thickness between around 10 nm and 100 nm. In the case where the material of the lower electrode 102 is suited to diffusing ions into the solid electrolyte 104 (this is then known as a “soluble” electrode), an ion diffusion barrier may be arranged between the lower electrode 102 and the solid electrolyte 104. Such an ion diffusion barrier is for example formed by a portion of Wn and/or TiN and/or any other material suited to preventing a diffusion of ions into the solid electrolyte 104 from the lower electrode 102. The thickness of this ion barrier is for example between around 10 nm and 20 nm.

A portion of ionisable metal 106, or active metal, for example based on silver and/or copper, is arranged on the solid electrolyte 104. This metal is described as ionisable because during its deposition on the solid electrolyte 104 or a step of thermal diffusion or by radiation, this metal diffuses metal ions into the solid electrolyte 104. An upper electrode 108 based on a conductor material, for example based on an inert metal such as tungsten and/or nickel, is arranged on the portion of ionisable metal 106. The thickness of the upper electrode 108 is for example between around 100 nm and 300 nm. In the case where the material of the upper electrode 108 is suited to diffusing ions into the solid electrolyte 104, a diffusion barrier, for example similar to that described previously, may be arranged between the upper electrode 108 and the portion of ionisable metal 106.

The solid electrolyte 104 comprises metal ions of nature similar to the metal of the portion of ionisable metal 106, stemming from the portion of ionisable metal 106. These metal ions have migrated from the portion of ionisable metal 106 into the solid electrolyte 104 during the deposition of the portion of ionisable metal 106 on the solid electrolyte 104, and/or if necessary after a subsequent diffusion step (for example by a heat treatment or by UV radiation) In an alternative, the metal ions may be integrated in the solid electrolyte 104 directly during the deposition of this solid electrolyte 104, for example by co-sputtering of the solid electrolyte 104 and the. ionisable metal 106.

The concentration of metal ions in the solid electrolyte 104 is less than the saturation concentration of metal ions of the material of the solid electrolyte 104 and is generally speaking for example between around 5% and 50%. The value of the saturation concentration of metal ions in the solid electrolyte 104 is a function of the nature of the metal ions, as well as the nature of the material of the solid electrolyte. For example, in the case of a solid electrolyte 104 based on GeSe and a portion of ionisable metal 106 based on Ag, the saturation concentration of silver ion in the solid electrolyte 104 is equal to around 30%. Here, a concentration of silver ion, in the GeSe, less than around 30% is thus chosen.

The lower electrode 102, the assembly formed by the solid electrolyte 104 and the portion of ionisable metal 106, and the upper electrode 108 are respectively surrounded by dielectric portions 110, 114 and 116 intended to thermally and electrically isolate the protective device 100. These dielectric portions are for example based on SiO₂ and/or Si₃N₄.

Such a device 100 has small dimensions: for example, the total thickness of the solid electrolyte 104 and the portion of ionisable metal 106 may be equal to around 65 nm, forming a protective device 100 of thickness equal to around 265 nm when the electrodes each have a thickness equal to around 100 nm. The diameter of the protective device 100 is for example equal to around 300 nm.

FIG. 3 represents the protective device 100 according to a second embodiment. Compared to the first embodiment described previously, the protective device 100 according to the second embodiment further comprises a portion of resistive material 112 arranged between the lower electrode 102 and the solid electrolyte 104. In an alternative of this second embodiment, this portion of resistive material 112 could also be arranged between the upper electrode 108 and the portion of ionisable metal 106. The resistive material of this portion 112 is chosen such that it has a conductivity less than that of the material of the lower electrode 102 and/or the upper electrode 108, thereby forming a series resistor inside the device 100 between the lower electrode 102 and the upper electrode 108, and making it possible to limit the current flowing through the protective device 100 between the electrodes 102 and 108 and thus to protect the device 100 from any destruction if it is subjected to a too high ESD. The dimensions of this portion of resistive material 112 are chosen as a function of the requisite resistance and the resistivity of the material of this resistive portion 112.

The maximum current that the protective device 100 can withstand is determined experimentally and the resistance that the protective device 100 is intended to have is calculated from the value of this maximum current and parameters linked to the device to be protected, such that the maximum duration during which current may flow through the device to be protected, or instead the maximum peak voltage that can be withstood by the device to be protected. The material of this resistive portion 112 may be chosen so that it does not diffuse ions into the solid electrolyte 104. In the case where the material of this portion 112 is suited to diffusing ions into the solid electrolyte 104, a diffusion barrier, for example similar to those described previously, may be arranged between this portion of resistive material 112 and the solid electrolyte 104.

The device 100 has, between its two electrodes 102 and 108, a conductivity, the value of which is overall defined by the conductivity of the assembly formed by the solid electrolyte 104 and the portion of ionisable metal 106, and possibly the resistive portion 112. However, the conductivity of this assembly depends on the voltage applied to its terminals, in other words the voltage applied between the electrodes 102 and 108.

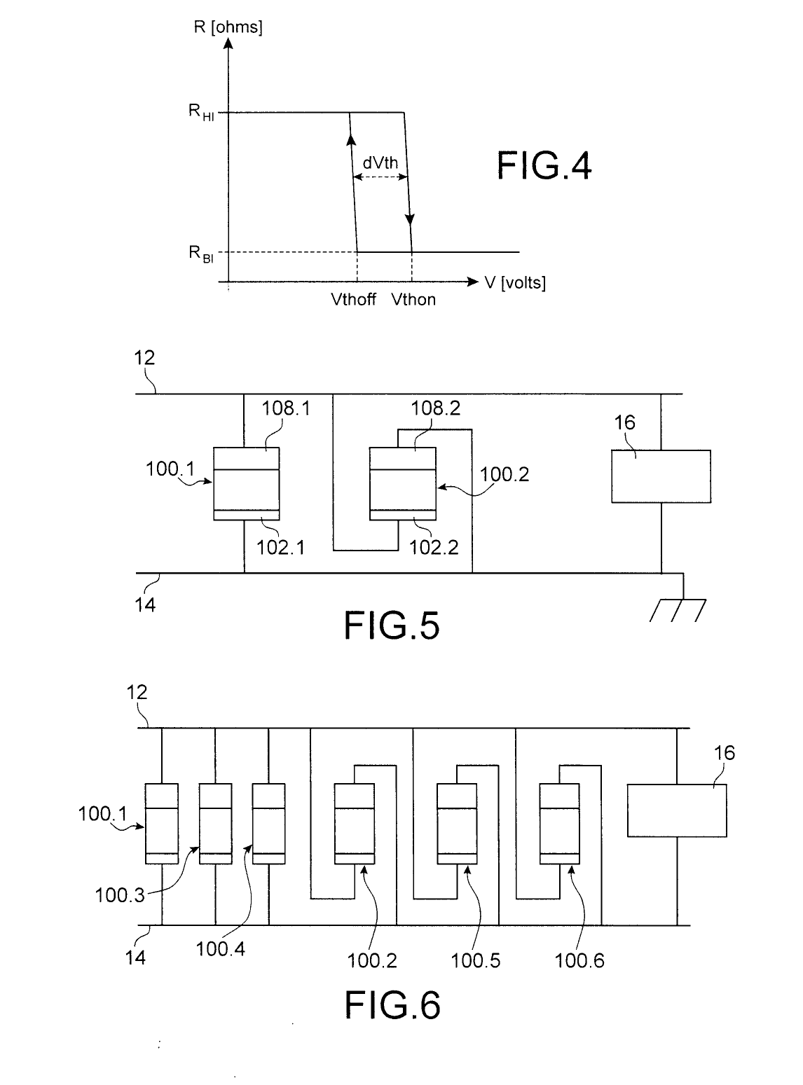

FIG. 4 graphically represents the variation in this conductivity (in ohms) as a function of the value of the voltage (in volts) applied between the electrodes 102 and 108. The device 100 has a first stable high impedance state R_{H}: (with for example R_{HI}>10⁹ ohms, or instead 10⁶<R_{HI}<10⁹ ohms), and a second low impedance state R_{BI} (with for example R_{BI}<10³ ohms, or instead 10<R_{BI}<10³ ohms) being triggered when the voltage between the electrodes 102, 108 exceeds a threshold voltage Vₜₕₒₙ, for example between around 500 mV and 5 V. Preferably, a threshold voltage Vₜₕₒₙ approaching as closely as possible the limit breakdown voltage of the materials used in the protective device 100 is chosen. The return from the low impedance state R_{BI} to the high impedance state R_{HI} takes place automatically when the value of the voltage between the electrodes 102, 108 returns below a threshold V_{thoff}, for example between around 200 mV and 2V, and of value less than the value of the threshold voltage Vₜₕₒₙ. In FIG. 4, it will be seen that the value of V_{thoff} is less than that of Vₜₕₒₙ, forming a hysteresis dVₜₕ.

During the appearance of an ESD, the voltage at the terminals of the electrodes 102 and 108 of the device 100 exceeds the threshold voltage Vₜₕₒₙ. The metal ions found in the solid electrolyte 104 then form a conduction path in the electrolyte 104 by a phenomenon of migration, causing the passage of the conductivity of the device 100 from the first high impedance state R_{HI} to the second low impedance state R_{BI}. The ESD may thus be evacuated through the protective device 100. When the ESD is terminated, the voltage between the electrodes 102, 108 drops, returning below the threshold V_{thoff} and leading to the elimination of the conduction path formed previously in the electrolyte 104 by the dispersion of the metal ions having previously migrated into the electrolyte 104. The protective device 100 then returns automatically to the stable high impedance state R_{HI}.

Several parameters of the protective device 100 make it possible to modify the switching voltages Vₜₕₒₙ, V_{thoff} and the hysteresis dVₜₕ:

the nature of the ionisable metal 106,

the nature of the material of the solid electrolyte 104,

the quantity of metal ions diffused into the solid electrolyte 104,

the diffusion coefficient of the ionisable metal 106,

the addition of dopants into the solid electrolyte 104.

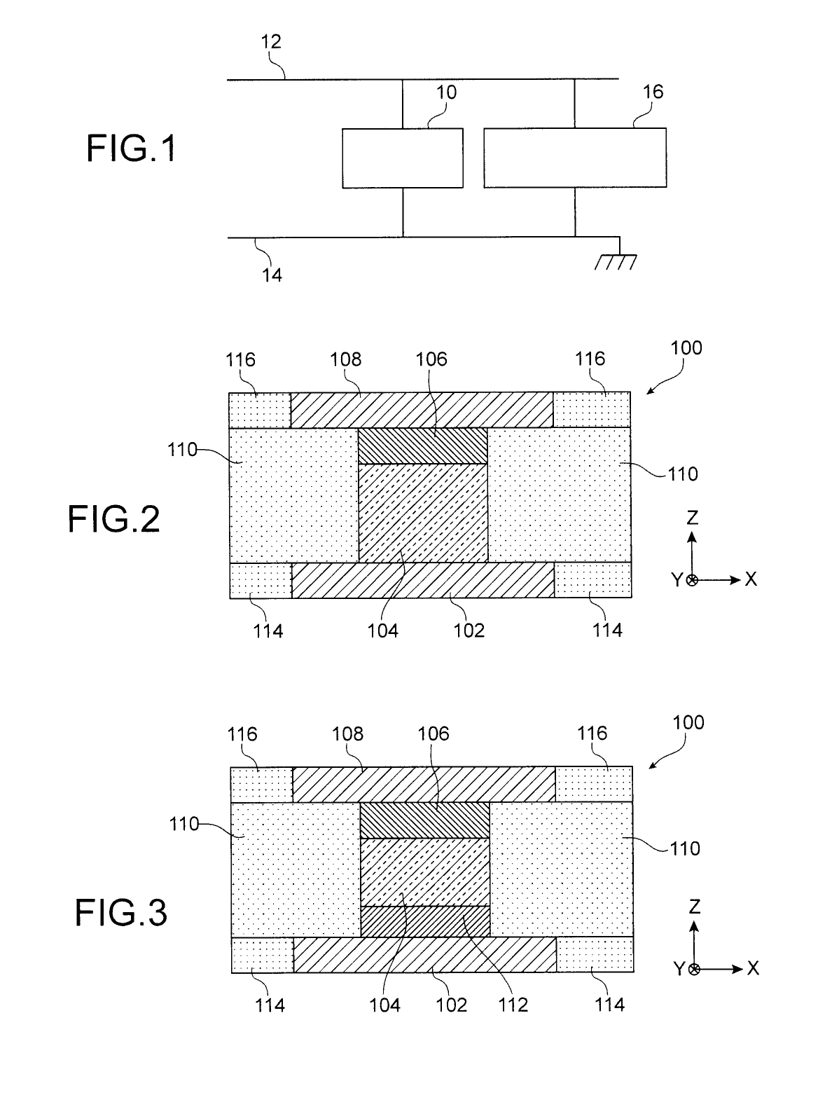

FIG. 5 represents an example of configuration in which an integrated circuit 16 is protected from electrostatic discharges. By analogy with the configuration represented in FIG. 1, the integrated circuit 16 to be protected comprises an input and/or output line 12 and a line 14 connected to earth. A first protective device 100.1 as described previously according to the first or the second embodiment is connected in parallel to the integrated circuit 16, between the input/output line 12 and the earth 14, upstream of the integrated circuit 16. A second protective device 100.2 is also connected in parallel to the integrated circuit 16, between the input/output line 12 and the earth 14, and also upstream of the integrated circuit 16. The upper electrode 108.1 of the first protective device 100.1 is electrically connected to the input/output line 12, the lower electrode 102.1 of the first protective device 100.1 being electrically connected to earth 14. Conversely, the upper electrode 108.2 of the second protective device 100.2 is electrically connected to earth 14 and the lower electrode 102.2 of the second protective device 100.2 is electrically connected to the input/output line 12.

Thus, given that each of the protective devices 100.1 and 100.2 has a unipolar operation (passage from the high impedance state R_{HI} to the low impedance state R_{BI} in the presence of a positive voltage between the lower electrode 102 and the upper electrode 108), this coupling makes it possible to assure a bipolar protection of the integrated circuit 16, protecting it from ESD of value equally well positive or negative appearing on the input/output line 12. Nevertheless, if it is wished to assure a unipolar protection of the integrated circuit 16, it is possible only to connect a single protective device 100 between the input/output line 12 and the earth 14, in parallel and upstream of the integrated circuit 16 to be protected. In this case, the protective device will be connected like the first device 100.1 or like the second device 100.2 according to the type of electrostatic discharges from which the integrated circuit 16 has to be protected.

Given that the dimensions of the protective device 100 are small, it can withstand a current of maximum value Iₘₐₓ flowing through it. If an integrated circuit has to be protected from ESD entailing currents of values greater than Iₘₐₓ, it is in this case possible to use several protective devices 100 connected in parallel to each other. FIG. 6 represents an example of such a configuration in which six protective devices 100.1 to 100.6 are connected in parallel to the integrated circuit 16, between the input/output line 12 and the earth 14, upstream of the integrated circuit 16. Among these six protective devices 100.1 to 100.6, three first protective devices 100.1 to 100.3 comprise their upper electrodes connected to the input/output line 12 and their lower electrodes connected to earth 14, three second protective devices 100.4 to 100.6 comprise their upper electrodes connected to earth 14 and their lower electrodes connected to the input/output line 12. A bipolar protection of the CMOS device 16 achieved by six protective devices 100 is thereby obtained, thus making it possible to withstand heavy currents of electrostatic discharges, the discharge current being regularly spread out between three of the protective devices 100 according to the sign of the electrostatic overvoltage.

The example of FIG. 6 may be generalised: an integrated circuit 16 may be protected by N protective devices 100, where N is a strictly positive integer. In addition, in the case of a bipolar protection, a part of the N protective devices may be connected in a reverse manner to the integrated circuit 16 compared to the other protective devices, in an analogous manner to the configuration previously described in reference to FIG. 6. In addition, the number of protective devices connected in a reverse manner between the input/output line and the earth is not necessarily equal to the number of protective devices connected in a non reversed manner between the input/output line and the earth.

A method of forming the protective device 100 described previously will now be disclosed.

The lower electrode 102 is firstly formed by depositing a layer of conductor material intended to form this lower electrode 102, for example by sputtering, CVD (chemical vapour deposition), PECVD (plasma enhanced chemical vapour deposition), evaporation or any other suitable deposition technique, on a semi-conductor substrate, for example based on silicon, germanium, or instead AsGa, or instead of SOI type, not represented. This substrate may also be based on an organic material, the substrate being in this case electrically insulating. It is also possible that this conductor material is deposited on a metal layer itself arranged on the substrate and intended to form an electrical connection with other parts formed on the substrate and/or the connection lines of the integrated circuit(s) to be protected. The layer of conductor material deposited is then etched to form the lower electrode 102 according to the requisite dimensions and shape. The dimensions of the section of the lower electrode 102 that the currents of the electrostatic discharges are intended to flow through will be chosen as a function of the value of maximum current intended to flow through the protective device 100. This lower electrode may for example have sides of dimensions equal to around 1 μm, and a thickness equal to around 300 nm.

The dielectric portions 114 are then formed around the lower electrode 102 by deposition of a dielectric material and planarisation with stoppage on the lower electrode 102.

In the example of the second embodiment, a layer of resistive material is then deposited on the lower electrode 102 and on the dielectric portions 114, then etched in order to form the resistive portion 112. In the case of the first embodiment, these steps of forming the resistive portion 112 are omitted.

A layer of material intended to form the solid electrolyte 104, for example chalcogenide, is then deposited on the resistive portion 112 or on the lower electrode 102, as well as on the dielectric portions. A layer of the ionisable metal, for example based on copper and/or tungsten, intended to form the portion of ionisable metal 106 then being deposited on the layer of material of the solid electrolyte 104. Metal ions stemming from the layer of ionisable metal 106 diffuse into the layer of chalcogenide material intended to form the solid electrolyte 104 during the deposition of the ionisable metal 106 on the layer of the solid electrolyte 104. These layers (intended to form the solid electrolyte 104 and the portion of ionisable metal 106), and possibly the resistive material 112, are then etched according to the requisite dimensions to form the solid electrolyte 104 and the portion of ionisable metal 106. If some of the materials used (apart from the active material 106) are suited to diffusing ions into the solid electrolyte 104, it is possible to implement steps of forming diffusion barriers between the electrolyte 104 and these materials, by depositing for example layers of appropriate materials between the parts in question and the solid electrolyte 104 and by etching them to the requisite dimensions.

It is also possible to implement a step of doping of the solid electrolyte 104, for example when this material is not intrinsically doped, for example by a thermal diffusion of dopants stemming from a layer of dopants deposited beforehand on the solid electrolyte 104 and from which the dopants self-diffuse during the deposition, or by a UV exposure or an additional heat treatment. In addition, it is also possible to increase the concentration of metal ions in the solid electrolyte 104 by an additional diffusion step that can consist in a heat treatment or a UV radiation carried out on the portion of ionisable metal 106 and the solid electrolyte 104.

The quantity of metal ions diffused in the solid electrolyte is chosen such that the concentration of metal ions in the solid electrolyte is less than the value of the saturation concentration of these ions in the solid electrolyte. When this value of the saturation concentration is unknown, the value of the concentration of metal ions in the solid electrolyte to be formed may be obtained by implementing the following successive tests:

firstly an initial concentration of metal ions in the solid electrolyte is chosen,

the switching voltage V_{THon} is measured,

if V_{THon}>destruction voltage of the device to be protected, the concentration of metal ions in the solid electrolyte is then increased in order to lower the value of V_{THon} and this is done up to obtaining V_{THon}<destruction voltage of the device to be protected (while having V_{THon}>operating voltage (or supply voltage) of the protective device). When the concentration obtained makes it possible to have V_{THon}<destruction voltage of the device to be protected, it is checked whether V_{THoff}>0 is indeed met. If these conditions are met, then the concentration of metal ions in the solid electrolyte is thus well below the saturation concentration,

if V_{THon}<operating voltage (or supply voltage) of the protective device, the concentration of metal ions is then reduced up to having V_{THon}>operating voltage (or supply voltage) of the protective device (while having V_{Thon}<destruction voltage of the device to be protected). It is also checked whether V_{THOff}>0 is indeed met. If these conditions are met, then the concentration of metal ions in the solid electrolyte is thus well below the saturation concentration.

Dielectric portions 110 are then formed by deposition and planarisation around the parts 112, 104 and 106. Finally, the upper electrode 108 as well as the dielectric portions 116 are formed, for example in a similar manner to the lower electrode 102 and the dielectric portions 114.

Generally speaking, the materials used to form the different parts of the protective device 100 may be deposited by sputtering, CVD (chemical vapour deposition), evaporation or any other suitable deposition technique, and etching and/or planarisation, for example CMP (chemical mechanical polishing).

The thickness of the solid electrolyte 104 formed is calculated in particular as a function of the nature of the material forming the electrolyte (for example a doped chalcogenide), the value of the resistance at the high impedance state R_{HI} (this resistance value being proportional to the thickness of material according to the relation

$$R = \frac{σ \cdot e}{S} ,$$

where e is the thickness of the material, σ the resistivity of the material, and S the surface area of the material in contact with the ionisable metal), the geometry of the material (particularly the surface area S) and the breakdown voltage of the material (the breakdown electrical field being greater than the switching voltage of the device).

The thickness of the portion of ionisable metal 106 is determined as a function of the material of the electrodes 102, 108, the type of dissolution in the electrolyte (spontaneous diffusion and/or diffusion stimulated by a UV doping or a heat treatment of the ionisable metal 106), the requisite switching voltage Vₜₕₒₙ and the thickness of the solid electrolyte 104. The thickness of the portion of ionisable metal 106 may for example be between around 5 nm and 100 nm.

In addition, the concentration of metal ions stemming from the portion of ionisable metal 106 in the solid electrolyte 104 may be adjusted to obtain the requisite switching voltage. This switching voltage is preferably chosen less than a saturation voltage to guarantee a spontaneous return to the high impedance state. This adjustment may be obtained by choosing an adequate thickness of the portion of ionisable metal 106, this optimal thickness may be determined by different experimental tests.

In the examples represented in FIGS. 2 and 3, the lower electrode 102 and the upper electrode 108 have dimensions greater than those of the parts 112, 104 and 106 in a plane (x,y) (along the axes x, y and z represented in FIGS. 2 and 3). Thus, the surface area of the active zone of the protective device 100 (this surface area corresponding to that which is flowed through by a current during the dissipation of electrostatic discharges) is defined by the surface area of the solid electrolyte 104 in the plane (x,y), this surface area being similar to the surface area of the portion of ionisable metal 106 in this same plane. This surface area is for example between around 700 nm² to 0.07 μm².

In an alternative, it is possible to have electrodes having dimensions less than those of the parts 112, 104 and 106 in the plane (x,y). The surface area of the active zone of the protective device 100 is then determined by the dimensions of the electrodes 102, 108 in the plane (x,y).

1. A device for protecting at least one integrated circuit against an electrostatic discharge, comprising at least:
a portion of ionisable metal,
a solid electrolyte arranged against the portion of ionisable metal and comprising metal ions of nature similar to the metal of said portion of ionisable metal,
an electrode electrically connected to the solid electrolyte,
and in which the concentration of metal ions in the solid electrolyte is less than the saturation concentration of the metal ions in the solid electrolyte.

2. The protective device according to claim 1, further comprising a second electrode electrically connected to the portion of ionisable metal.

3. The protective device according to claim 1 of which the proportion of ionisable metal is based on copper and/or silver, and/or the solid electrolyte is based on a chalcogenide, and/or the electrode(s) are based on nickel and/or tungsten.

4. The protective device according to claim 1, in which the thickness of he electrode(s) is between around 100 nm and 300 nm, and/or the thickness of the solid electrolyte is between around 10 nm and 100 nm, and/or the thickness of the portion of ionisable metal is between around 5 nm and 100 nm.

5. The protective device according to claim 1, further comprising, when the material of the electrode(s) is suited to diffusing ions into the solid electrolyte, an ion diffusion barrier arranged between the electrode(s) and the solid electrolyte.

6. The protective device according to claim 1, further comprising a portion of resistive material of conductivity less than that of the material of the electrode(s), arranged between the electrode and the portion of ionisable metal, or between the electrodes.

7. The protective device according to claim 6, further comprising, when the material of said portion of resistive material is suited to diffusing ions into the solid electrolyte, an ion diffusion barrier arranged between said portion of material and the solid electrolyte.

8. The protective device according to claim 1, the parts of which are surrounded by portions of electrically insulating material.

9. A method of protecting at least one integrated circuit against an electrostatic discharge, comprising at least the electrical connection of at least one protective device according to claim 1 to an electrical input and/or output line of the integrated circuit, one of the electrodes or the portion of ionisable metal of the protective device being electrically connected to the electrical input and/or output line of the integrated circuit, the other being electrically connected to an earth.

10. The protection method according to claim 9, wherein, when the protective device comprises a second electrode electrically connected to the portion of ionisable metal, the portion of ionisable metal is electrically connected to the electrical input and/or output line of the integrated circuit or to earth by means of the second electrode.

11. The protection method according to claim 9, further comprising the electrical connection of at least one second protective device according to claim 1, to the electrical input and/or output line of the integrated circuit, and wherein, when the portion of ionisable metal of the first protective device is electrically connected to the electrical input and/or output line of the integrated circuit, the electrode of the second protective device is electrically connected to the electrical input and/or output line of the integrated circuit and the portion of ionisable metal of the second protective device is electrically connected to earth, and when the portion of ionisable metal of the first protective device is electrically connected to earth, the portion of ionisable metal of the second protective device is electrically connected to the electrical input and/or output line of the integrated circuit and the electrode of the second protective device is electrically connected to earth.

12. The protection method according to claim 11, wherein, when the second protective device comprises a second electrode electrically connected to the portion of ionisable metal of the second protective device, the portion of ionisable metal of the second protective device is electrically connected to the electrical input and/or output line of the integrated circuit or to earth by means of the second electrode.

13. A method of dissipating an electrostatic discharge appearing on at least one electrical input and/or output line of at least one integrated circuit, comprising at least the steps of:
transfer of a current stemming from the electrostatic discharge into a protective device according to claim 1 by means of an electrode or a portion of ionisable metal of the protective device electrically connected to the electrical input and/or output line of the integrated circuit or to an earth,
migration of metal ions, stemming from the portion of ionisable metal and diffused into a solid electrolyte of the protective device arranged against the portion of ionisable metal, into the solid electrolyte, lowering the resistivity of the assembly formed by at least the portion of ionisable metal and the solid electrolyte and forming a conductive path between the electrode and the portion of ionisable metal,
evacuation of the current stemming from the electrostatic discharge through the protective device, by means of the electrode or the portion of ionisable metal electrically connected to earth.

14. The dissipation method according to claim 13, wherein, during the migration of the metal ions, the resistivity of the assembly formed by the portion of ionisable metal and the solid electrolyte is lowered from a R_{HI} value greater than around 10⁹ ohms to a R_{BI} value less than around 10³ ohms.

15. The dissipation method according to claim 13, further comprising, after the step of evacuation of the current stemming from the electrostatic discharge, a step of dispersing the metal ions having previously migrated into the solid electrolyte, increasing the resistivity of the assembly formed by the portion of ionisable metal and the solid electrolyte.

16. The dissipation method according to claim 15, wherein, during the dispersion of the metal ions, the resistivity of the assembly formed by the portion of ionisable metal and the solid electrolyte is increased from a R_{BI} value less than around 10³ ohms to a R_{HI} value greater than around 10⁹ ohms.
